(19) United States
(12) Patent Application Publication
(10) Pub. No.: US 2026/0093532 A1
(43) Pub. Date: Apr. 2, 2026

(54) SYSTEM AND METHOD FOR ENERGY AWARE SCHEDULING OF ARTIFICIAL INTELLIGENCE (AI) WORKLOADS

(71) Applicant: Wipro Limited, Bangalore (IN)

(72) Inventor: Prasanna Chandran MELNATAMI KRISHNARAM, Cedar Park, TX (US)

(73) Assignee: Wipro Limited, Bangalore (IN)

(21) Appl. No.: 19/005,842

(22) Filed: Dec. 30, 2024

Related U.S. Application Data
(60) Provisional application No. 63/701,703, filed on Oct. 1, 2024.

(51) Int. Cl. G06F 9/48

(52) U.S. Cl. CPC G06F 9/4893; G06F 9/485

(57) ABSTRACT

The present invention relates to a method and system for execution of one or more AI workloads in an AI data center. The system is configured to create energy profiles for each AI workload, based on attributes associated with the AI workloads, which reflect their energy consumption characteristics. The system is configured to categorize AI workloads into execution categories based on the created energy profiles and a real-time energy availability of an electrical grid. The system is configured to create a dynamic schedule for execution of the AI workloads for a pre-defined time based on the execution categories. The dynamic schedule is based on the real-time energy availability of the electrical grid and user preferences for execution of the AI workloads. The system is configured to execute each of the AI workloads for the pre-defined time in the AI data center based on the dynamic schedule.

### CROSS-REFERENCE TO RELATED APPLICATIONS AND PRIORITY

The present application claims priority from U.S. Patent Provisional Application No. 63/701,703, filed on Oct. 1, 2024, which is incorporated herein by a reference.

### FIELD OF INVENTION

The presently disclosed embodiments are related, in general, to the field of scheduling and execution of Artificial Intelligence (AI) workloads. More particularly, the present disclosure relates to a method and a system for execution of one or more AI workloads in an AI data center by ensuring efficient execution while minimizing latency and maximizing throughput.

### BACKGROUND OF THE INVENTION

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

As Artificial Intelligence (AI) continues to permeate various sectors, the demand for efficient management of AI workloads has never been more critical. The AI workloads, which encompass activities such as training, inference, and deployment of machine learning models, often require substantial computational resources and energy consumption. The complexity of the AI workloads is compounded by a need to balance performance and resource utilization, especially in environments with limited energy availability. Scheduling the AI workloads presents several challenges, including optimizing resource allocation to ensure timely execution while minimizing energy costs. Moreover, increasing number of the AI workloads and fluctuating energy demands during peak hours further complicate scheduling efforts, leading to potential inefficiencies and increased operational costs. Such issues necessitate innovative approaches that not only prioritize performance but also account for energy management, making effective scheduling of the AI workloads a pressing concern for organizations leveraging AI technologies.

AI data centers, which consume substantial energy for both the training and the inferencing of AI models, face a pressing issue of energy management. Particularly during peak hours, availability of energy becomes a critical constraint. With hundreds of AI models queued for the training or the inferencing, balancing energy consumption during peak hours with operational demands of running appropriate models poses a complex technical challenge. During peak demand periods, strain on power grids can result in several issues, including voltage fluctuations, power shortages, and even potential blackouts. Such disruptions not only have economic and operational consequences but can also affect the training and the inferencing processes of the AI models. For instance, a power outage or a fluctuation in voltage can cause delays in the training process, data corruption, or even a complete interruption of ongoing computations. Such disruptions can significantly extend time required to develop the AI models and reduce overall efficiency of AI operations. Furthermore, the need for AI data centers to rely on backup power sources, such as diesel generators, during the disruptions further complicate the situation. The backup power sources are often less efficient, more costly, and contribute to increased carbon emissions, undermining overall sustainability goals of transitioning to cleaner energy systems.

Regarding conventional task scheduling and AI workload scheduling, while both concerned with optimizing allocation of computational resources, differ significantly in nature of tasks and complexity of scheduling algorithms. In general task scheduling, the tasks are usually less computationally intensive and typically rely on generic processors like Central Processing Units (CPUs). The tasks might involve running software applications, data processing, or even Software as a Service (SaaS) tasks. The scheduling algorithms for such tasks are often designed to balance load, avoid resource contention, and ensure priority-based execution. On the other hand, AI workload scheduling involves more specialized computational demands. AI workloads, such as deep learning, neural network training, and inference, often require specialized hardware like Graphical Processing Units (GPUs), Tensor Processing Units (TPUs), and large memory systems. The AI workloads are computationally intensive and exhibit highly variable energy consumption, depending on factors such as AI workload complexity, execution time, and a type of model being processed. The energy requirements of the AI workloads fluctuate significantly, making traditional task scheduling methods insufficient. The AI workload scheduling must consider not only the availability of computational resources but also real-time energy consumption profiles, power availability, and potential interruptions in energy supply. Additionally, the AI workloads often have long runtimes and need to be prioritized according to urgency, real-time requirements, and resource availability. Thus, the AI workload scheduling inherently is more complex, requiring more advanced techniques that can dynamically adapt to changes in energy demand, hardware limitations, and task requirements.

Thus, conventional scheduling approaches focus on resource availability without addressing energy optimization, leading to higher costs, inefficiencies, and potential disruptions. Additionally, absence of energy-aware scheduling mechanisms and energy profiling for the AI workloads results in ineffective management of resources, particularly when sudden energy fluctuations occur, highlighting a critical need for improved AI workload scheduling systems.

In light of the above-stated challenges, there exists a long-felt need of technical solutions in operational adjustment of AI workload management within cluster services and deployment frameworks. Additionally, there is a need for energy management of training the AI workloads that use data center as a service.

Further limitations and disadvantages of conventional and traditional approaches will become apparent to one of skill in the art, through the comparison of described systems with some aspects of the present disclosure, as set forth in the remainder of the present application and with reference to the drawings.

### SUMMARY OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

According to embodiments illustrated herein, a method for execution of Artificial Intelligence (AI) workloads in an AI data center is disclosed. The method may include a step of creating one or more energy profiles for execution of each of one or more AI workloads based on one or more attributes associated with each of the one or more AI workloads. Further, each of the one or more energy profiles may be indicative of energy consumption characteristics of each of the one or more AI workloads. Further, the method may include a step of categorizing each of the one or more AI workloads into one or more execution categories based on the one or more energy profiles and a real-time energy availability of an electric grid. Further, the method may include a step of creating a dynamic schedule for execution of each of the one or more AI workloads for a pre-defined time based on the one or more execution categories. Further, the dynamic schedule may be based on the real-time energy availability of the electric grid and one or more user preferences for execution of the one or more AI workloads. Further, the method may include a step of executing each of the one or more AI workloads for the pre-defined time in the AI data center based on the dynamic schedule. Further, the execution of the one or more AI workloads may be optimized based on the real-time availability of the electrical grid.

According to embodiments illustrated herein, a system for execution of Artificial Intelligence (AI) workloads in an AI data center is disclosed. Further, the system may include a memory and a processor. Further, the processor may be configured to execute programmed instructions stored in the memory for performing following operations. The processor may be configured to create one or more energy profiles for execution of each of one or more AI workloads based on one or more attributes associated with each of the one or more AI workloads. Further, each of the one or more energy profiles is indicative of energy consumption characteristics of each of the one or more AI workloads. Further, the processor may be configured to categorize each of the one or more AI workloads into one or more execution categories based on the one or more energy profiles and a real-time energy availability of an electrical grid. Further, the processor may be configured to create a dynamic schedule for execution of each of the one or more AI workloads for a pre-defined time based on the one or more execution categories. Further, the dynamic schedule may be based on the real-time energy availability of the electric grid and one or more user preferences for execution of the one or more AI workloads. Further, the processor may be configured to execute each of the one or more AI workloads for the pre-defined time in the AI data center based on the dynamic schedule. Further, the execution of the one or more AI workloads may be optimized based on the real-time energy availability of the electric grid.

According to embodiments illustrated herein, a non-transitory computer-readable storage medium having stored thereon, a set of computer-executable instructions causing a computer comprising one or more processors to perform one or more instructions. The processor may be configured to create one or more energy profiles for execution of each of one or more Artificial Intelligence (AI) workloads based on one or more attributes associated with each of the one or more AI workloads. Further, each of the one or more energy profiles may be indicative of energy consumption characteristics of each of the one or more AI workloads. Further, the processor may be configured to categorize each of the one or more AI workloads into one or more execution categories based on the one or more energy profiles and a real-time energy availability of an electric grid. Further, the processor may be configured to create a dynamic schedule for execution of each of the one or more AI workloads for a pre-defined time based on the one or more execution categories. Further, the dynamic schedule may be based on the real-time energy availability of the electric grid and one or more user preferences for execution of the one or more AI workloads. Further, the processor may be configured to execute each of the one or more AI workloads for the pre-defined time in an AI data center based on the dynamic schedule. Further, the execution of the one or more AI workloads may be optimized based on the real-time availability of the electrical grid.

The foregoing summary is illustrative only and is not intended to be in any way limiting. In addition to the illustrative aspects, embodiments, examples, and features described above, further aspects, embodiments, and features will become apparent by reference to the drawings and the following detailed description.

### BRIEF DESCRIPTION OF DRAWINGS

The accompanying drawings illustrate the various embodiments of systems, methods, and other aspects of the disclosure. Any person with ordinary skills in art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements.

The detailed description is described with reference to the accompanying figures. In the figures, the same numbers are used throughout the drawings to refer like features and components. Embodiments of the present disclosure will now be described, with reference to the following diagrams below wherein:

FIG. 1 illustrates a block diagram describing a system for execution of Artificial Intelligence (AI) workloads, in accordance with an embodiment of the present subject matter.

FIG. 2 illustrates a block diagram that illustrates various components of an application server configured for execution of the AI workloads in an AI data center, in accordance with an embodiment of the present subject matter.

FIG. 3 illustrates a flowchart describing a method for execution of the AI workloads in the AI data center, in accordance with an embodiment of the present subject matter.

FIG. 4 illustrates a flowchart describing a balancing method for execution of the AI workloads in the AI data center, in accordance with an embodiment of present subject matter.

FIG. 5 illustrates a flowchart describing an energy profile creation for execution of the AI workloads in the AI data center, in accordance with an embodiment of present subject matter.

FIG. 6 illustrates a block diagram of an exemplary computer system for implementing embodiments consistent with the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

To address the problems of conventional systems, the present disclosure relates to energy management of Artificial Intelligence (AI) workloads to optimize energy usage efficiently. The present disclosure relates to a method and system for execution of the AI workloads in an AI data center. The disclosed system may be implemented on an application server to optimize energy management by efficiently scheduling the AI workloads based on real-time energy availability, ensuring optimal energy usage. The disclosed system may be configured to receive AI workload information from one or more users and subsequently create one or more energy profiles for each AI workload. Further, the system may categorize the one or more energy profiles corresponding to low, medium, and high energy profiles based on energy requirements. Furthermore, the disclosed system may schedule the AI workloads according to the real-time energy availability from an electrical grid, prioritizing each AI workload from one or more AI workloads that align with current energy resources. Once the scheduling is complete, the disclosed system may execute the one or more AI workloads, while continuously checking progress of currently executing one or more AI workloads at each checkpointing interval. Furthermore, the disclosed system may check whether the execution of a current AI workload is completed. Additionally, after completion of the current AI workload, the disclosed system may be configured to schedule next set of the one or more AI workloads, again based on the real-time energy availability from the electrical grid, ensuring continuous and efficient execution of the one or more AI workloads in the AI data center.

The objective of the present disclosure is to optimize energy consumption during execution of the one or more AI workloads by developing an energy-aware scheduling system that ensures efficient alignment of the AI workload execution with the real-time energy availability from the electrical grid. The energy profiles for each AI workload are created based on a variety of AI workload attributes, such as operational parameters, data precision levels, Graphical Processing Unit (GPU) resources, and parallelism settings. The profiling enables AI data centers to better manage energy consumption, ultimately contributing to more sustainable and cost-effective operations.

The objective of the present disclosure is to categorize the one or more AI workloads into one or more execution categories based on energy consumption levels to strategically schedule the one or more AI workloads during specific time windows when the real-time energy availability is optimal. By categorizing the AI workloads into low priority category, medium priority category, and high priority category, the system can allocate resources in such a way that energy use is maximized during periods of peak availability while minimizing energy consumption during off-peak hours. Such targeted scheduling approach balances operational efficiency with environmental responsibility, reducing both carbon emissions and energy costs.

Another objective of the present disclosure is to improve the operational efficiency of the AI workload execution by incorporating a transitional checkpoint method between the one or more execution categories. The transitional checkpoint method allows the system to save a state of ongoing AI workloads before transitioning between other AI workloads, ensuring that the AI workload can resume seamlessly. The transitional checkpoint method reduces likelihood of energy inefficiencies caused by abrupt AI workload changes and provides a robust solution for scheduling the AI workloads without compromising continuity or performance.

Yet another objective of the present disclosure is to develop a comprehensive user requirement gathering portal for the AI workload execution in the AI data centers that ensures all relevant AI workload characteristics are collected accurately. By capturing essential data, such as data precision, input data format (text, image, video), language requirements, data size and structure, model framework, and backup frequency, the AI data centers can better assess and optimize energy usage for each specific AI workload. The user requirement gathering portal ensures that users provide necessary information for proper AI workload categorization and resource allocation.

Yet another objective of the present disclosure is to create an adaptive AI workload management system that takes into account energy consumption characteristics of different hardware and ensures that the AI data center resources are aligned with specific energy demands of the AI workloads. This includes considering factors such as the type of GPU hardware, networking requirements, and memory compatibility. By doing so, the system guarantees that the AI workloads are processed with most energy-efficient hardware configurations, reducing unnecessary power consumption and maximizing hardware utilization.

Yet another objective of the present disclosure is to provide a solution for balancing high-performance AI workload execution with environmental sustainability by utilizing renewable energy sources and adapting AI workload schedules to availability of green energy. Since renewable energy sources are often intermittent, the system incorporates mechanisms that dynamically adjust the scheduling of the AI workloads to maximize use of clean energy during high-availability periods while minimizing reliance on non-renewable sources during peak energy demand.

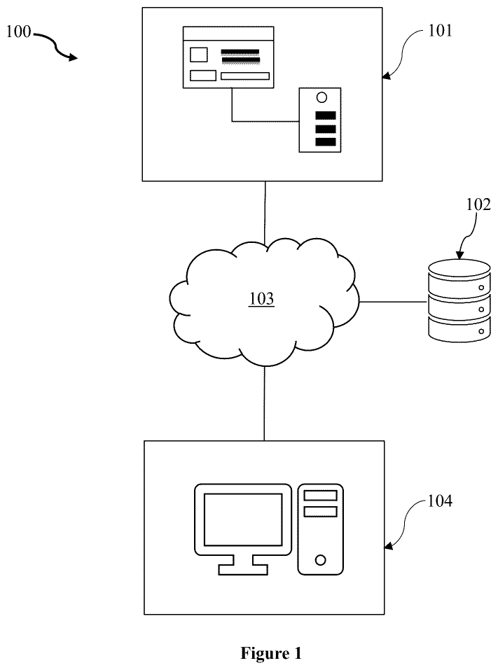

FIG. 1 illustrates a block diagram of a system (100) for execution of one or more AI workloads, in accordance with at least one embodiment. The system 100 typically includes an application server 101, a database server 102, a communication network 103, and a user computing device 104. The application server 101, the database server 102, and the user computing device 104 are typically communicatively coupled with each other via the communication network 103. In an embodiment, the application server 101 may communicate with the database server 102, and the user computing device 104 using one or more protocols such as, but not limited to, Hypertext Transfer Protocol (HTTP), Transmission Control Protocol/Internet Protocol (TCP/IP), Wireless Application Protocol (WAP), Radio Frequency (RF) mesh, Bluetooth Low Energy (BLE), and the like, to communicate with one another.

In an embodiment, the database server 102 may refer to a computing device that may be configured to store collected information from one or more users, details of one or more energy profiles, one or more AI workload information, one or more execution categories of the one or more AI workloads, checkpoint intervals, checkpointed data, and real-time energy availability from an electrical grid. In an embodiment, the database server 102 may include a special purpose operating system specifically configured to perform one or more database operations on the collected information from the one or more users. In an embodiment, the database server 102 may be interpreted as an external storage. In an embodiment, the external storage may store various states of checkpointed one or more AI workloads. The external storage may provide a state of the checkpointed one or more AI workloads if the checkpointed one or more AI workloads are selected for execution. In an embodiment, the database server 102 may include one or more instructions specifically for storing the details of the one or more energy profiles and step by step formula to calculate total final energy consumption. In an exemplary embodiment, the one or more energy profiles may include input data based on constraints and requirements, data preprocessing, infrastructure profiling, user data profiling, energy consumption estimation, optimization, energy profile generation, validation and feedback. Examples of database operations may include, but are not limited to, storing, retrieving, computing, scheduling, checkpointing, and managing information associated with the one or more AI workloads. In an embodiment, the database server 102 may include hardware that may be configured to perform one or more specific operations. In an embodiment, the database server 102 may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server 102 may be configured to utilize the application server 101 for storage and retrieval of information associated with the one or more AI workloads for optimizing energy usage by efficiently scheduling the one or more AI workloads.

A person with ordinary skills in art will understand that the scope of the disclosure is not limited to the database server 102 as a separate entity. In an embodiment, the functionalities of the database server 102 can be integrated into the application server 101 or into the user computing device 104.

In an embodiment, the application server 101 may refer to a computing device or a software framework hosting an application or a software service. In an embodiment, the application server 101 may be implemented to execute procedures such as, but not limited to, programs, routines, or scripts stored in one or more memories for supporting the hosted application or the software service. In an embodiment, the hosted application or the software service may be configured to perform one or more specific operations. The application server 101 may be realized through various types of application servers such as, but are not limited to, a Java application server, a .NET framework application server, a Base4 application server, a PHP framework application server, or any other application server framework.

In another embodiment, the application server 101 may be configured to utilize the database server 102 and the user computing device 104, in conjunction, for energy aware scheduling of the one or more AI workloads. In an implementation, the application server 101 is configured for optimizing energy management by efficiently scheduling the one or more AI workloads based on the real-time energy availability. Further, the application server 101 may be configured to create the one or more energy profiles for each AI workload, schedule the one or more AI workloads, and monitor performance of the one or more AI workloads ensuring reduced energy consumption while maintaining system efficiency.

In yet another embodiment, the application server 101 may be configured to receive AI workload information from the one or more users. In yet another embodiment, the application server 101 may be configured to create the one or more energy profiles for the one or more AI workloads. In yet another embodiment, the application server 101 may be configured to categorize the one or more AI workloads into a low priority category, a medium priority category and a high priority category. In yet another embodiment, the application server 101 may be configured to schedule the one or more AI workloads based on energy availability from the electric grid. In yet another embodiment, the application server 101 may be configured to execute a currently selected AI workload. In yet another embodiment, the application server 101 may be configured to checkpoint a currently executing AI workload. In yet another embodiment, the application server 101 may be configured to check if the execution of the current AI workload is completed. In yet another embodiment, the application server 101 may be configured to end execution of the current AI workload. Further, the application server 101 may continue with scheduling of new one or more AI workloads based on energy availability from the electrical grid.

In an embodiment, the communication network 103 may correspond to a communication medium through which the application server 101, the database server 102, and the user computing device 104 may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared radiation, IEEE 802.11, 802.16, 2G, 3G, 4G, 5G, 6G, 7G cellular communication protocols, and/or Bluetooth (BT) communication protocols. The communication network 103 may either be a dedicated network or a shared network. Further, the communication network 103 may include a variety of network devices, including routers, bridges, servers, computing devices, storage devices, and the like. The communication network 103 may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing device 104 may include one or more processors and one or more memories. The one or more memories may include computer readable code that may be executable by one or more processors to perform specific operations. In an embodiment, the user computing device 104 may present a web user interface to transmit a user input to the application server 101. Example web user interfaces may be presented on one or more portable devices to display a dynamic schedule of the one or more AI workloads based on energy availability from the electrical grid to the user to facilitate interaction within the system 100. Examples of the user computing devices may include, but are not limited to, a personal computer, a laptop, a personal digital assistant (PDA), a mobile device, a tablet, or any other computing device.

The system 100 can be implemented using hardware, software, or a combination of both, which includes using where suitable, one or more computer programs, mobile applications, or “apps” by deploying either on-premises over the corresponding computing terminals or virtually over cloud infrastructure. The system 100 may include various micro-services or groups of independent computer programs which can act independently in collaboration with other micro-services. The system 100 may also interact with a third-party or external computer system. Internally, the system 100 may be the central processor of all requests for transactions by the various actors or users of the system. The system actively monitors energy consumption and considers real-time factors such as energy availability, cost, and resource demand when scheduling the one or more AI workloads across various computing infrastructures. By integrating received data on energy usage, the system 100 adjusts the execution of the one or more AI workloads to align with periods of optimal energy availability, reducing waste, and improving overall energy efficiency. The scheduling mechanism ensures that GPU, CPU, and network resources are utilized effectively while prioritizing the AI workloads based on energy-efficient principles. Such a technical approach not only enhances performance of the one or more AI workloads but also minimizes energy footprint of computational infrastructure of the AI data center, leading to both cost savings and a more sustainable operation.

In an exemplary embodiment, the disclosed system enables execution of the one or more AI workloads across various AI computing infrastructures including Cloud Service Providers (CSP) specifically for AI model training purposes. The present disclosure requires adequate GPU resources to handle complex one or more AI workloads by providing the necessary computational power for training and inference AI workloads. In the present disclosure, CPU resources are required to support general-purpose processing and managing the orchestration of the one or more AI workloads and High bandwidth Network Interface Cards (NICs) are required to ensure fast data transfer rates between different components of the AI compute infrastructure, facilitating efficient communication and data exchange. Further, in the present disclosure a scheduling application is required to prioritize and allocate resources effectively, ensuring optimal performance and energy efficiency of the one or more AI workloads. An energy monitoring system from the electrical grid is configured to track and manage energy consumption, enabling the system 100 to make informed decisions about the AI workload scheduling based on the real-time energy availability. Thus, the present disclosure is designed to optimize utilization of AI hardware infrastructure in the AI data center by aligning the AI workload execution with energy availability from the electrical grid.

In an exemplary embodiment, the system 100 may be configured to continuously monitor energy fluctuations within the hardware inventory and the real-time energy availability of the electric grid. Further, the system 100 may be configured to identify a faulty hardware inventory based on the monitoring. Further, the system 100 may initiate creation of a checkpoint based on the energy fluctuations and the identified faulty hardware inventory.

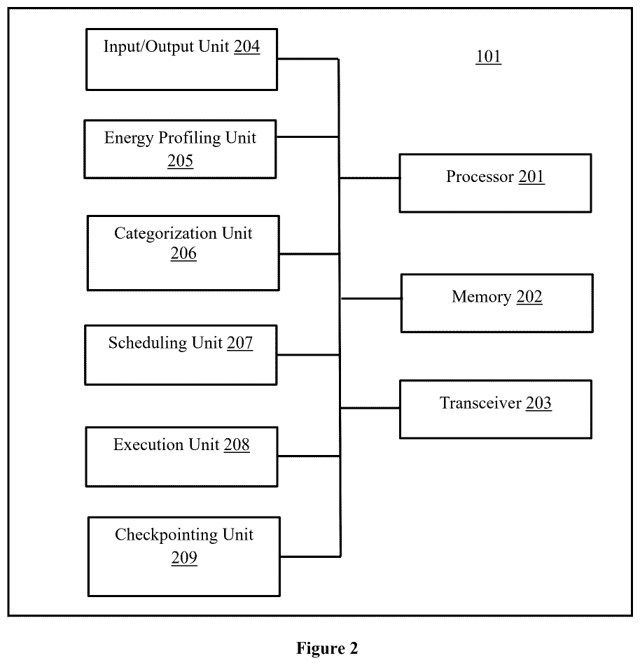

Now referring to FIG. 2, illustrates a block diagram showing an overview of various components of the application server 101 configured for the execution of the one or more AI workloads, in accordance with at least one embodiment of the present disclosure. FIG. 2 is explained in conjunction with elements from FIG. 1. In an embodiment, the application server 101 includes a processor 201, a memory 202, a transceiver 203, an input/output unit 204, an energy profiling unit 205, a categorization unit 206, a scheduling unit 207, an execution unit 208, and a completion checking unit 210. The processor 201 may be communicatively coupled to the memory 202, the transceiver 203, the input/output unit 204, the energy profiling unit 205, the categorization unit 206, the scheduling unit 207, the execution unit 208, and the completion checking unit 210. The transceiver 203 may be communicatively coupled to the communication network 103 of the system 100.

The processor 201 includes suitable logic, circuitry, interfaces, and/or code that may be configured to execute a set of instructions stored in the memory 202, and may be implemented based on several processor technologies known in the art. The processor 201 works in coordination with the memory 202, the transceiver 203, the input/output unit 204, the energy profiling unit 205, the categorization unit 206, the scheduling unit 207, the execution unit 208, the checkpointing unit 209, for execution of the one or more AI workloads. Examples of the processor 201 include, but not limited to, a standard microprocessor, microcontroller, central processing unit CPU, an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present disclosure.

The memory 202 includes suitable logic, circuitry, interfaces, and/or code that may be configured to store the set of instructions, which are executed by the processor 201. Preferably, the memory 202 is configured to store one or more programs, routines, or scripts that are executed in coordination with the processor 201. Additionally, the memory 202 may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory 202 may be removable, non-removable, or a combination thereof. Further, the memory 202 may include routines, programs, objects, components, data structures, etc., which perform particular tasks or implement particular abstract data types. The memory 202 may include programs or coded instructions that supplement the applications and functions of the system 100. In one embodiment, the memory 202, amongst other things, serves as a repository for storing data processed, received, and generated by one or more of the programs or the coded instructions. In yet another embodiment, the memory 202 may be managed under a federated structure that enables the adaptability and responsiveness of the application server 101.

The transceiver 203 includes suitable logic, circuitry, interfaces, and/or code that may be configured to receive, process or transmit information, data or signals, which are stored by the memory 202 and executed by the processor 201. In an embodiment, the transceiver 203 may be configured to receive one or more attributes associated with each of the one or more AI workloads and one or more user preferences from the one or more users, via the UI, for creating the one or more energy profiles. In an embodiment, the transceiver 203 may be configured to receive energy limitation information associated with the electrical grid. In an embodiment, the transceiver 203 may be configured to receive infrastructure information associated with the AI data center. The transceiver 203 is preferably configured to receive, process or transmit, one or more programs, routines, or scripts that are executed in coordination with the processor 201. The transceiver 203 is preferably communicatively coupled to the communication network 103 of the system 100 for communicating all the information, data, signals, programs, routines or scripts through the network 103.

The transceiver 203 may implement one or more known technologies to support wired or wireless communication with the communication network 103. In an embodiment, the transceiver 203 may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver 203 may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VOIP), Wi-MAX, a protocol for email, instant messaging, and/or Short Message Service (SMS).

The input/output (I/O) unit 204 includes suitable logic, circuitry, interfaces, and/or code that may be configured to receive or present information. The input/output unit 204 includes various input and output devices that are configured to communicate with the processor 201. Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit 204 may include a variety of software and hardware interfaces, for example, a web interface, a graphical user interface, and the like. The I/O unit 204 may allow the system 100 to interact with the user directly or through the user computing devices 104. Further, the I/O unit 204 may enable the system 100 to communicate with other computing devices, such as web servers and external data servers (not shown). The I/O unit 204 can facilitate multiple communications within a wide variety of networks and protocol types, including wired networks, for example, LAN, cable, etc., and wireless networks, such as WLAN, cellular, or satellite. The I/O unit 204 may include one or more ports for connecting a number of devices to one another or to another server. In one embodiment, the I/O unit 204 allows the application server 101 to be logically coupled to other user computing devices 104, some of which may be built in.

The energy profiling unit 205 includes suitable logic, circuitry, interfaces, and/or code that may be configured to perform one or more preprocessing operations on the energy limitation information, the infrastructure information, and the one or more user preferences. The energy profiling unit 205 may be configured to create the one or more energy profiles for execution of each of the one or more AI workloads based on the one or more attributes associated with each of the one or more AI workloads. The energy profiling unit 205 may be configured to create a baseline energy profile for each of the hardware inventory. The energy profiling unit 205 may be configured to estimate one or more computational requirements for execution of the one or more AI workloads based on the one or more user preferences and data associated with the one or more AI workloads.

The energy profiling unit 205 may be configured to estimate an energy consumption requirement for execution of the one or more AI workloads based on the one or more computational requirements. The energy profiling unit 205 may be configured to optimize the energy consumption characteristics by adjusting a computational load distribution across the hardware inventory. The energy profiling unit 205 may be configured to create the one or more energy profiles comprising the energy consumption requirement for the hardware inventory and the software inventory based on the adjusting and the energy limitation information. The energy profiling unit 205 may be configured to generate one or more recommendations for updating the one or more energy profiles based on the real-time energy availability of the electrical grid.

The categorization unit 206 includes suitable logic, circuitry, interfaces, and/or code that may be configured to categorize each of the one or more AI workloads into one or more execution categories based on the one or more energy profiles and the real-time energy availability of the electrical grid.

The scheduling unit 207 includes suitable logic, circuitry, interfaces, and/or code that may be configured to create a dynamic schedule for execution of each of the one or more AI workloads for a pre-defined time based on the one or more execution categories. In an embodiment, the dynamic schedule is based on the real-time energy availability of the electrical grid and one or more user preferences for the execution of the one or more AI workloads.

The execution unit 208 includes suitable logic, circuitry, interfaces, and/or code that may be configured to execute each of the one or more AI workloads for the pre-defined time in the AI data center based on the dynamic schedule. In an embodiment, the execution of the one or more AI workloads is optimized based on the real-time energy availability of the electrical grid.

The checkpointing unit 209 includes suitable logic, circuitry, interfaces, and/or code that may be configured to create a checkpoint associated with a first AI workload. The checkpoint stores a state of ongoing execution of the first AI workload and data associated with the ongoing execution of the first AI workload. The checkpointing unit 209 may be configured for continuously monitoring for energy fluctuations within the hardware inventory and the real-time energy availability of the electrical grid. The checkpointing unit 209 may be configured to identify a faulty hardware inventory based on the monitoring and initiate creation of a checkpoint based on the energy fluctuations and the faulty hardware inventory.

In operation, the transceiver 203 may receive information from the one or more users to train AI models or for execution of the one or more AI workloads. Furthermore, the information may be collected through an interface such as a web portal. In an embodiment, the one or more AI workloads includes at least one of data processing workloads, machine learning workloads, deep learning workloads, Natural Language Processing (NLP) workloads, generative AI workloads, computer vision workloads. In an embodiment, the one or more AI workloads corresponds to either a training AI workload or an inference AI workload, and the AI data center which includes the application server 101 is a cloud-based data center configured for execution of the one or more AI workloads.

In an embodiment, the transceiver 203 may be configured for receiving energy limitation information associated with the electrical grid. The energy limitation information includes at least one of day-of-use constraints and peak power limits. Further, the transceiver 203 may be configured for receiving infrastructure information associated with the AI data center. In an embodiment, the infrastructure information includes a hardware inventory and a software inventory. The hardware inventory includes at least one of Graphics Processing Unit (GPU), Central Processing Unit (CPU), memory, and network. Further, the transceiver 203 may be configured for receiving the one or more user preferences for the execution of the one or more AI workloads. The one or more user preferences includes data precision, size, format, and framework.

In an exemplary embodiment, the collected information may include various critical parameters, such as data precision (integers, fixed point, or binary floating point with 8, 16, or 32-bit formats), input data formats (text, image, or video), and the language requirements (single or multi-language). The collected information may also include details on the data size and structure, including the volume of data, batch size, and data quality, which may be structured, semi-structured, or unstructured (such as social media data). The preferred type of foundation model (open, purchased, or pre-trained) is also captured, as it determines the foundation model size, with examples like Llama3, GPT, BERT, CLIP, DALL-E, and SAM. Additionally, the collected information may include a model framework and version (e.g., TensorFlow, PyTorch) which are further inputs to ensure compatibility with the AI data center infrastructure. Furthermore, the collected information may include the checkpoint and a backup frequency, as well as GPU and CPU scaling efficiency and memory requirements. Furthermore, the transceiver 203 may provide the collected information to the energy profiling unit 206.

After receiving the aforementioned information, the energy profiling unit 205 may be configured for performing one or more preprocessing operations on the energy limitation information, the infrastructure information, and the one or more user preferences. In an embodiment, the one or more preprocessing operations corresponds to a normalizing operation and a validation operation. Further, the energy profiling unit 205 may be configured to create the one or more energy profiles for the one or more AI workloads based on the collected information and the other received information. In an exemplary embodiment, the other information received may include existing data center infrastructure details, including hardware components such as GPU, CPU, memory, network, and software availability, or a combination thereof. In an embodiment, the other information may further include power limitations from the grid, such as day-of-use constraints, peak power limits, and other grid-related restrictions. Additionally, the energy profiling unit 205 may incorporate collected information from the one or more users including data precision, size, format, framework, and other critical parameters. In an embodiment, each of the one or more energy profiles is indicative of energy consumption characteristics of each of the one or more AI workloads.

In an exemplary embodiment, the process of energy profiling for the one or more AI workloads may involve several steps to ensure efficient energy management. The steps may involve gathering of input data, which includes constraints such as power limitations from the electrical grid, existing hardware and software infrastructure, and the one or more user preferences regarding data precision, size, format, and framework. The next step may involve data preprocessing, where the input data is normalized, standardized, and validated to meet predefined formats and constraints. Furthermore, infrastructure profiling may assess the performance and energy consumption characteristics of existing hardware and software, creating baseline energy profiles for GPUs, CPUs, memory, and network resources. Furthermore, user data profiling may analyse computational requirements based on the precision, size, and format of the data to estimate energy consumption. In an embodiment, using these profiles, total energy consumption may be estimated while ensuring compliance with grid power limitations. Optimization may involve adjusting the computational load distribution across available hardware, considering trade-offs between performance and energy efficiency based on user preferences. In an embodiment, final steps in the energy profiling may include generating a detailed energy profile that outlines estimated energy consumption for each component and the overall system, along with recommendations for optimizing energy usage. In another embodiment, the energy profiling may include a step of validation and feedback. The generated energy profile may be validated against real-world data, and the one or more user feedback may be collected to iterate on the system, enhancing both accuracy and efficiency.

In another embodiment, the energy profiling unit 205 may be configured to create one or more energy profiles for execution of each of the one or more AI workloads based on the one or more attributes associated with each of the one or more AI workloads. Further, each of the one or more energy profiles may be indicative of energy consumption characteristics of each of the one or more AI workloads. Further, the one or more attributes may include operational parameters, data precision values, a page size, GPU hardware resources, input data format, type of languages, data size, data structure, preferred type of a pre-trained model, a pre-trained model framework and version, a checkpoint interval, a backup frequency, memory requirements, and parallelism settings. Further, the one or more attributes may be indicative of an estimated energy consumption by each of the one or more AI workloads.

Moreover, the energy profiling unit 205 may be configured to determine a final total energy consumption of each AI workload, as performed by the application server 102. The energy profiling unit 205) subsequently provides the energy profile of each AI workload to the categorization unit 206, enabling efficient categorization based on energy requirements.

In an exemplary embodiment, the energy profiling unit 205 employs a step-by-step formula to calculate the final total energy consumption of each AI workload. The step begins with a data preprocessing energy requirement (Dpre), Eₚᵣₑ=Dₚᵣₑ·C_{data}. The energy required for data preprocessing may be proportional to size, format, and complexity of a user data (Cdata). The next step may include component B_{comp}=Σ(E_{gpu}+E_{cpu}+Eₘₑₘ+Eₙₑₜ). The baseline energy consumption (Bcomp) is the sum of energy consumed by each hardware component based on their performance and energy profiles. The next step may include total energy consumption based on user data T_{comp}=B_{comp}+Eₚᵣₑ·f(C_{data}). Total energy consumption depends on both the baseline hardware consumption and the energy required to process the user data. That is the total computational energy requirement (Tcomp) encompasses the energy needed for processing the user data and the baseline hardware consumption. To optimize energy usage, the load distribution across available hardware components is analyzed, leading to an optimized energy consumption value (Ocomp).

$${O}_{comp} = \sum ( \frac{{T}_{comp}}{{H}_{comp}} \cdot {w}_{eff} ) .$$

The optimized energy consumption is based on distribution across the available hardware components including GPU, CPU, memory, and network. The total energy consumption (Etotal) is then estimated by combining this optimized load distribution with the computational requirements for the user data. Eₜₒₜₐₗ=O_{comp}+T_{comp}. Additionally, the final total energy consumption (Fenergy) must comply with the power limitation from the grid (Plim), F_{energy}=min(Pₗᵢₘ, Eₜₒₜₐₗ), ensuring that energy use remains within the grid's capacity while maximizing efficiency based on a weight for efficiency (Weff) that reflects user preferences for performance versus energy savings. Thus, the formula for final total energy consumption becomes

$${F}_{energy} = min ( {P}_{lim} , ( \sum ( \frac{{T}_{comp}}{{H}_{comp}} \cdot {w}_{eff} ) + {T}_{comp} ) ) .$$

In an exemplary embodiment, the energy profiling unit 205 may be configured to analyze the energy consumption characteristics of the system 100 by considering some variables that influence energy utilization and optimization. These variables include, but not limited to,
P_lim: Power limitation from the grid (Watts), which defines the maximum allowable power drawn from the energy source.
H_comp: Hardware components such as GPU, CPU, memory, and network resources, which have varying energy consumption and performance profiles.
C_data: User data profiles characterized by parameters like precision, size, and format, which impact computational and energy requirements.
C_pref: User preferences, which define the trade-offs between energy efficiency and performance, guiding the prioritization of AI workloads.
E_comp: Energy consumption of each hardware component, which is individually measured and monitored to ensure precise profiling.
D_pre: Energy requirements for data preprocessing, which includes cleaning, transformation, and preparation AI workloads before main computations.
T_comp: Total computational energy requirement derived from the cumulative energy consumption of all active AI workloads and hardware components.
B_energy: Baseline energy profile of the hardware (Watt-hours), representing the inherent energy consumption when the system is idle or running at minimal load.
O_energy: Optimized energy consumption calculated based on load distribution strategies that balance performance and energy efficiency.
F_energy: Final total energy consumption (Watts), accounting for all AI workloads, optimizations, and grid energy constraints.

By leveraging these variables, the energy profiling unit 206 may generate detailed energy profiles for each AI workload. This allows the system to dynamically categorize, schedule, and optimize the AI workloads in alignment with the real-time energy availability and user-defined priorities, thereby ensuring sustainable and cost-efficient operations while maintaining high performance.

Further, the categorization unit 206 may be configured to categorize each of the one or more AI workloads into one or more execution categories based on the one or more energy profiles and the real-time energy availability of the electrical grid. In an embodiment, the one or more energy profiles for the one or more AI workloads may be received and real-time energy availability from the electrical grid may be received. Further, the categorization unit 206 may be configured to categorize each of the one or more AI workloads into one or more execution categories based on the one or more energy profiles and the real-time energy availability of the electrical grid. Further, the one or more execution categories may include a low priority category, a medium priority category, and a high priority category.

In an embodiment, the low priority category may include of a first set of AI workloads from the one or more AI workloads which may be scheduled during a first pre-defined time. Further, the energy availability of the electrical grid may be below a first pre-defined threshold during the first pre-defined time. Further, the medium priority category may include of a second set of AI workloads from the one or more workloads which are scheduled during a second pre-defined time. Further, the energy availability of the electrical grid may be within a range of the first pre-defined threshold and a second pre-defined threshold during the second pre-defined time. Further, the high priority category includes of a third set of AI workloads from the one or more AI workloads which may be scheduled during the third pre-defined time window. Further, the energy availability of the electrical grid may be greater than the second pre-defined threshold during the third pre-defined time. Further, the categorization unit 206 may provide the one or more AI workloads categorized into the one or more execution categories to the scheduling unit 206 for further process.

The scheduling unit 207 may be configured to create the dynamic schedule for execution of each of the one or more AI workloads for a pre-defined time based on the one or more execution categories. In an embodiment, the pre-defined time may be one of the first pre-defined time, the second pre-defined time, or the third pre-defined time. In an embodiment, the dynamic schedule is based on the real-time energy availability of the electrical grid and the one or more user preferences for the execution of the one or more AI workloads.

In an exemplary embodiment, the scheduling unit 207 may schedule the one or more AI workloads in three scenarios including first instance which corresponds to a scenario when no AI workloads are currently executing. The second instance corresponds to a scenario when a currently running AI workload is checkpointed and the scheduling unit 207 receives a scheduling notification from the checkpointing unit 209. The third instance corresponds to a scenario when the currently running AI workload is completed and the scheduling notification is received from the checkpointing unit 209. Furthermore, the scheduling unit 207 may either select a new AI workload for execution or choose an already existing AI workload that was checkpointed previously. Additionally, the scheduling unit 207 may provide a currently selected AI workload to the execution unit 208 for further process.

The execution unit 208 may be configured to execute each of the one or more AI workloads for the pre-defined time in the AI data center based on the dynamic schedule. The execution of the one or more AI workloads is optimized based on the real-time energy availability of the electrical grid.

In an embodiment, the execution of each of the one or more AI workloads includes initiating execution of a first AI workload for the pre-defined time. Further, the execution unit 208 may be configured for transitioning from the first AI workload to a second AI workload upon the execution of the first AI workload for the pre-defined time. Further, the checkpointing unit 209 may be configured for creating a checkpoint associated with the first AI workload. The checkpoint stores a state of ongoing execution of the first AI workload and data associated with the ongoing execution of the first AI workloads.

The checkpointing unit 209 may be configured to check if the execution of the current AI workload is completed. In an embodiment, the checkpointing unit 209 may receive the completion check notification at completion check intervals of the AI workload from the checkpointing unit (209). In an exemplary embodiment, the checkpointing unit 209 may check for the status of the AI workload to be completed, and if the AI workload is not completed, the checkpointing unit 209 may notify the execution unit 208 to continue the execution of the AI workload. In another exemplary embodiment, if the status of the AI workload may be completed, the checkpointing unit 209 may end the AI workload and send the AI workload completion information. In another embodiment, the checkpointing unit 209 may send the scheduling notification after AI workload completion to the scheduling unit 207. In an embodiment, the checkpointing unit (209) may receive the checkpointing notification at each checkpointing interval of the AI workload from the execution unit 208. In another embodiment, the checkpointing unit 209 may perform the checkpointing of the currently executing AI workload and store a state of the AI workload in the external storage. In yet another embodiment, the checkpointing unit 209 may send the scheduling notification to the scheduling unit 207 after AI workload checkpointing.

Further, execution unit 208 may be configured for initiating execution of the second AI workload from the one or more AI workloads for the pre-defined time. Further, execution unit 208 may be configured for resuming execution of the first AI workload for the pre-defined time based on the checkpoint on the execution of the second AI workload for the pre-defined time. In an embodiment, the pre-defined time is one of the first pre-defined time, the second pre-defined time, and the third pre-defined time.

As illustrated above, if a checkpointed AI workload is selected for execution, then the execution unit 208 may load a checkpointed data from the external storage. In an embodiment, the execution unit 208 may provide a checkpointing notification at each checkpointing interval of the AI workload to the checkpointing unit 209. In another embodiment, the execution unit (208) may provide a completion check notification at completion check interval of the AI workload to the checkpointing unit 209. Moreover, the execution unit 208 may receive a notification from the transceiver 203 to continue executing the AI workload if completion check is found to be negative.

In an exemplary embodiment, a checkpoint method as described above ensures that before transitioning from one AI workload to another AI workload, the current AI workload is properly checkpointed. The checkpointing method saves the state of the ongoing AI model training (AI workload), allowing the system to seamlessly resume or switch to another AI workload based on the next scheduled AI workload.

Further, the checkpointing unit 209 may be configured to continuously monitor for energy fluctuations within the hardware inventory and the real-time energy availability of the electrical grid. The checkpointing unit 209 may be configured to identify a faulty hardware inventory based on the monitoring. Further, the checkpointing unit 209 may be configured to initiate creation of a checkpoint based on the energy fluctuations and the faulty hardware inventory. This transitional strategy and creation of checkpoints not only enhances the operational efficiency of AI systems but also ensures that energy consumption is optimized in accordance with real-time fluctuations in grid energy availability, thereby promoting sustainable and cost-effective AI operations in an AI data center.

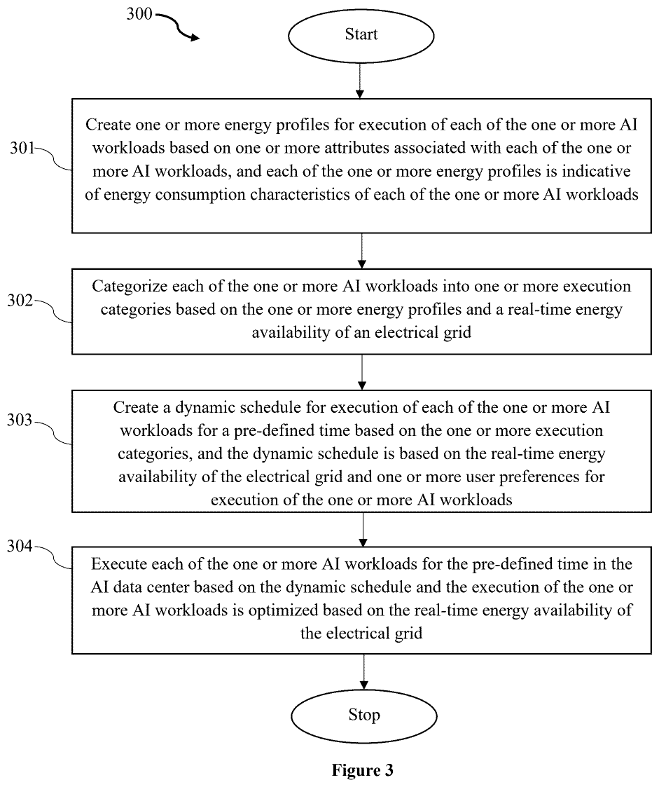

FIG. 3 illustrates a flowchart describing a method 300 for execution of the one or more AI workloads in the AI data center, in accordance with an embodiment of present subject matter. The flowchart is described in conjunction with FIG. 1 and FIG. 2.

At step 301, the method 300 includes creating one or more energy profiles for execution of each of the one or more AI workloads based on one or more attributes associated with each of the one or more AI workloads and each of the one or more energy profiles is indicative of energy consumption characteristics of each of the one or more AI workloads.

At step 302, the method 300 includes categorizing each of the one or more AI workloads into one or more execution categories based on the one or more energy profiles and a real-time energy availability of an electrical grid.

At step 303, the method 300 includes creating a dynamic schedule for execution of each of the one or more AI workloads for a pre-defined time based on the one or more execution categories, and the dynamic schedule is based on the real-time energy availability of the electrical grid and one or more user preferences for execution of the one or more AI workloads.

At step 304, the method 300 includes executing each of the one or more AI workloads for the pre-defined time in the AI data center based on the dynamic schedule. In an embodiment, the execution of the one or more AI workloads is optimized based on the real-time energy availability of the electrical grid.

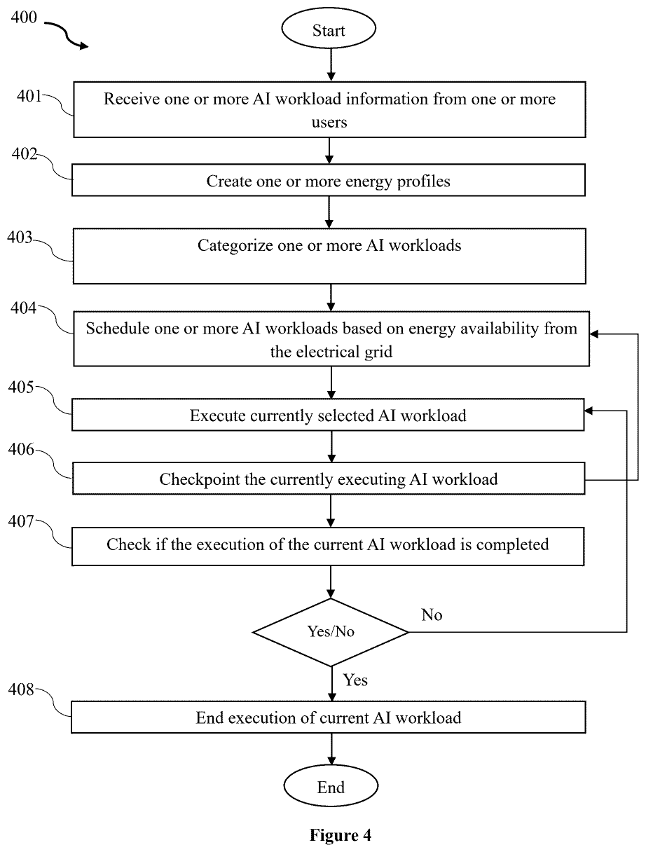

FIG. 4 illustrates a flowchart describing a method 400 for execution of the one or more AI workloads in the AI data center, in accordance with an embodiment of the present disclosure. The flowchart is described in conjunction with FIG. 1 and FIG. 2.

The method 400 starts at step 401 and proceeds up to step 408. The method 400 may be performed by the application server 101.

In operation, the method 400 may involve a variety of steps for scheduling the one or more AI workloads to optimize energy usage efficiency.

At step 401, the method 400 includes receiving AI workload information from one or more users. In an exemplary embodiment, a data center or the cloud service provider (CSP) may collect information from the one or more users who want to train an AI model. The information may be collected through a web portal. In another embodiment, the CSP continuously accepts one or more AI workloads from the one or more users globally and timestamps the same.

In an exemplary embodiment, the collected information may include various parameters, such as, but not limited to, data precision (integers, fixed point, or binary floating point with 8, 16, or 32-bit formats), input data formats (text, image, or video), and the language requirements (single or multi-language). The collected information may also include details on the data size and structure, including the volume of data, batch size, and data quality, which may be structured, semi-structured, or unstructured (such as social media data). The preferred type of foundation model (open, purchased, or pre-trained) is also captured, as it determines the foundation model size, with examples like Llama3, GPT, BERT, CLIP, DALL-E, and SAM. Additionally, the collected information may include a model framework and version (e.g., TensorFlow, PyTorch) which are critical inputs to ensure compatibility with the data center infrastructure. Furthermore, the collected information may include the checkpoint and backup frequency, as well as GPU and CPU scaling efficiency and memory requirements.

At step 402, the method 400 includes creating the one or more energy profiles for received one or more based on the collected information and the other received information.

In an exemplary embodiment, the information received may include existing AI data center infrastructure details, including hardware components such as GPU, CPU, memory, network, and software availability, or a combination thereof. In an embodiment, the information received may include power limitations from the grid, such as day-of-use constraints, peak power limits, and other grid-related restrictions. Additionally, the energy profiling unit 205 may incorporate collected information from the one or more users including data precision, size, format, framework, and other critical parameters.

In another exemplary embodiment, profiling of the one or more AI workloads based on energy does not necessarily dictate that low energy AI workload will follow high or medium energy AI workloads, instead, profiling indicates the amount of energy required to run or train each specific AI workload. Thus, energy profiling helps in understanding the energy demands of each of the AI workloads, allowing for more informed scheduling and resource allocation based on real-time energy availability.

In an embodiment, the step 402 of creating the one or more energy profiles, via the energy profiling unit 205 may be configured to determine the final total energy consumption of each AI workload. This step provides the energy profile of each AI workload to the categorization unit 205, enabling efficient categorization based on energy requirements.

At step 403, the method 400 includes categorizing the one or more AI workloads into the one or more execution categories comprising a low priority category, a medium priority category, and a high priority category. In an embodiment, the one or more AI workloads may be categorized into the one or more execution categories based on the energy profiles and the real-time energy availability of the electrical grid.

In an exemplary embodiment, multiple pipelines may be created using YAML or Jenkins to facilitate the categorizing of the one or more AI workloads, and the granularity of one or more execution categories depends on an amount of AI workload considered by the AI data center and a precision of energy availability from the electrical grid. For instance, AI workloads consuming less than 100 MW may be classified as low priority category, those between 100 to 500 MW as medium priority category, and those exceeding 500 MW as high priority category. However, it is ultimately up to the AI data center or the cloud service provider (CSP) to determine how they wish to further refine the categorization. For example, within the low priority category, the CSP might distinguish between Low 1 (under 50 MW), Low 2 (51 to 75 MW), and Low 3 (76 to 100 MW), and similar subdivisions may be made for medium priority category and high priority category.

At step 404, the method 400 includes scheduling the one or more AI workloads based on energy availability from the electric grid. In an exemplary embodiment, the scheduling unit 207 may schedule the one or more AI workloads in three scenarios including first instance which corresponds to a scenario when there are no AI workloads currently executing. When there are no AI workloads currently executing, the scheduling process begins by checking the real-time energy availability from the grid. Based on this availability, the method selects the AI workloads from the one or more execution categories. If the available energy is low, the AI workload categorized as a low priority category is chosen to run. If the energy is at a medium level, a medium priority category AI workload is selected. Conversely, when energy availability is high such as during nighttime an AI workload categorized under the high priority category is selected. After selecting the appropriate AI workload based on energy conditions, the system proceeds to the next step 405 in the scheduling process.

The second instance corresponds to when the currently running AI workload is checkpointed, the method checks the real-time energy availability from the electric grid. If the energy availability remains unchanged, the execution of the currently checkpointed AI workload continues. However, if the energy availability is changed, the new AI workload is selected for execution based on real time energy availability. Specifically, when the current energy availability is low, and earlier it corresponds to medium energy or high energy, the low energy categorized AI workload is selected to be executed. When the current energy availability is medium, and earlier it corresponds to low energy or high energy, the medium energy categorized AI workload is selected to be executed. When the current energy availability is high, and earlier it corresponds to low energy or medium energy, the high energy categorized AI workload is selected to run. The selected AI workload can either be the new AI workload running for the first time or the existing AI workload that was previously checkpointed. For example, if a low energy AI workload was initially chosen for execution when grid energy was limited, but later in the evening, energy availability increases, a new or previously saved high energy AI workload may be selected for execution. Likewise, if a high energy AI workload was running overnight and energy availability decreases in the early morning, the low energy or a medium energy AI workload will be loaded for execution. After this selection process, the method 400 returns to the previous step 405 to continue the AI workload management process.

The third instance corresponds to when the currently running AI workload is completed and the scheduling notification is received from the checkpointing unit 209. Thus, upon the completion of the currently running AI workload, the method 400 checks the real-time energy availability from the electrical grid to determine the next AI workload for execution. Depending on the energy levels, the method 400 selects an appropriate AI workload; if energy availability is low, the low energy categorized AI workload is chosen; if energy availability is medium, the medium energy AI workload is selected; and if energy availability is high such as during nighttime the high energy AI workload is executed. The selected AI workload can either be a new AI workload running for a first time or an existing AI workload that was previously checkpointed. In the event that multiple AI workloads fall within the same one or more execution categories, various techniques may be employed by the Cloud Service Provider (CSP) for selection. In an exemplary embodiment, these techniques may include First in First Out (FIFO) based on timestamps, prioritizing throughput to maximize the number of completed AI workloads in a short timeframe or giving preference to users who have paid a premium price for the AI workloads over those with basic pricing. The method (400) then continues back to step 405 for further AI workload management.

At step 405, the method 400 includes executing the currently selected AI workload. In an embodiment, the currently selected AI workload may be provided appropriate resources for execution i.e. for training AI models for user. In an exemplary embodiment, if the checkpointed AI workload may be selected, then the checkpointed data is loaded in the AI data center from the external storage.

At step 406, the method 400 includes checkpointing the currently executing AI workload. In an exemplary embodiment, checkpointing may be performed for the currently executing AI workload at each checkpointing interval, which may be determined based on existing industry practices, particularly in higher node clusters, taking into account the interruption rate of the cluster and user requirements. For AI data centers with high number of GPUs, careful consideration is given to establishing the checkpointing interval. The checkpointing unit 209 continuously monitors method performance, and at periodic intervals, a checkpoint is created, saving the status of all hardware and software components in the database server. The results of the checkpointing are stored in the external storage equipped with high-bandwidth memory to reload the checkpointed data in the AI data center quickly when required. After the checkpointing, the flow again goes to the first instance or the second instance for either scheduling another one or more AI workloads or continue with existing AI workload based on energy availability from the electric grid.

In another exemplary embodiment, the checkpointing method uses a monitoring approach which constantly checks for any sudden energy fluctuations caused by the racks containing the GPUs, tracks, isolates, and identifies any faulty GPUs. The energy entering the data center from the electrical grid may be monitored to ensure AI workload requirements are met, and when there is a threat to AI workload efficiency, then the CPU may be alerted to initiate the checkpointing process to ensure current training is saved.

At step 407, the method 400 includes checking if the execution of the current AI workload is completed. In an embodiment, at each completion check interval, the step 407 may check whether the execution of the current AI workload is completed or not. If the execution of the AI workload is completed, the method 400 goes to step 408. If the execution of the AI workload is not completed, then the method 400 goes to step 405. In an exemplary embodiment, the completion check interval may be pre-defined or configurable as per the data center or the CSP requirements.

At step 408, the method 400 includes ending execution of the current AI workload. In an embodiment, the currently executing AI workload is ended after its completion. Further, all the resources being utilized by the AI workload are freed. As a subsequent step, the flow moves to the third instance for scheduling new one or more AI workload.

This sequence of steps may be repeated and continue from step 404 by scheduling AI workloads based on energy availability from the electric grid.

Following is a detailed example of the present disclosure. Let us consider a scenario where a mid-sized IT company wishes to train a custom AI model using a cloud-based AI infrastructure. The company submits their AI workload information, such as data format (images and text), model framework (PyTorch), and the size of the training data, through a web portal connected to the energy profiling unit 205. This collected information is then sent to the transceiver unit 203, which creates an energy profile based on the user's data precision, batch size, and computational requirements. The system also considers the real-time grid power constraints and available AI data center resources, including GPU and CPU capacity. The categorization unit 206 categorizes the AI workload into a medium-energy execution category, as it requires substantial but manageable energy to train the custom AI model. Based on the real-time energy availability from the electric grid, the scheduling unit 207 selects the appropriate time to begin the AI workload, ensuring efficient energy use without exceeding grid power limits. As training progresses, the system periodically checkpoints the custom AI model's state, saving it to an external storage unit. If energy fluctuations or interruptions occur, the AI workload can seamlessly resume from the checkpoint, optimizing both energy usage and computational efficiency.

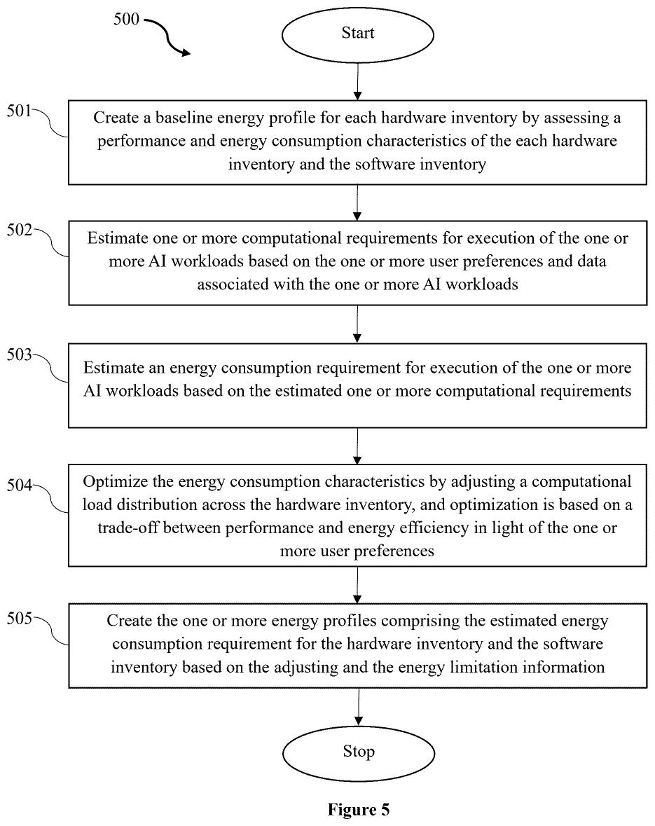

FIG. 5 illustrates a method 500 describing an energy profile creation of each of the one or more AI workloads for execution of the one or more AI workloads in the AI data center, in accordance with an embodiment of present subject matter. The method 500 may be performed by the application server (101) and particularly by the energy profiling unit 205.

At step 501, the method includes creating a baseline energy profile for each hardware inventory by assessing a performance and energy consumption characteristics of each hardware inventory and the software inventory.

At step 502, the method 500 includes estimating one or more computational requirements for execution of the one or more AI workloads based on the one or more user preferences and data associated with the one or more AI workloads.

At step 503, the method 500 includes estimating an energy consumption requirement for execution of the one or more AI workloads based on the one or more computational requirements.

At step 504, the method 500 includes optimizing the energy consumption characteristics by adjusting a computational load distribution across the hardware inventory. Further, the adjusting is based on a trade-off between performance and energy efficiency considering the one or more user preferences.

At step 505, the method 500 includes creating the one or more energy profiles comprising the estimated energy consumption requirement for the hardware inventory and the software inventory based on the optimization and the energy limitation information.

Following is a detailed working example of the present disclosure.

Consider a cloud-based AI data center utilized by a technology company, Y, to manage training and inference tasks for various machine learning models. Such tasks correspond to AI workloads. Y handles tasks from diverse domains, including language processing, image recognition, and predictive analytics, with varying computational and energy requirements.

Once the system receives the request from the Y, the system is configured to optimize energy usage and begins by creating energy profiles for each task from the one or more tasks. For instance, a deep learning model for image recognition is profiled based on its requirements such as high GPU usage, memory-intensive operations, and parallel execution capabilities. Similarly, a natural language processing (NLP) task, which involves transformer models, is characterized by medium GPU usage and large memory requirements but limited parallelism needs. After profiling, the one or more tasks are categorized into execution categories. For example, the image recognition task is classified into a high priority category due to its intensive GPU usage, suitable for execution during periods of peak renewable energy availability. Meanwhile, the NLP task is placed in a medium-priority category for execution during moderate energy availability, and data preprocessing tasks requiring minimal computational resources are scheduled in a low-priority category.

A dynamic schedule is then generated based on the energy availability of the electrical grid and user preferences. During daylight hours, when solar energy availability is high, high-priority tasks such as image recognition models are executed. In the evening, when the energy availability shifts to moderate levels, medium-priority tasks like NLP models are initiated. During off-peak hours, low-priority tasks like data preprocessing are scheduled, ensuring efficient energy utilization across the grid's fluctuations.

While executing these tasks (AI workloads), the system incorporates a transitional checkpoint method. For example, if the NLP task is interrupted due to a shift in energy availability, the system creates a checkpoint capturing the task's current state, including model weights and intermediate outputs. Once conditions are stabilized, the task resumes seamlessly, ensuring no loss of progress or data integrity. Additionally, the system continuously monitors energy consumption and hardware performance. For instance, during the execution of high-priority tasks, real-time metrics indicate that one GPU is underperforming due to thermal throttling. The system dynamically reallocates the task to another GPU with better performance, ensuring energy efficiency and uninterrupted execution. Further, the system is configured to optimizes energy profiles through adaptive configurations. For example, it reduces data precision for training models without significantly impacting accuracy, lowering computational demands and power usage. Furthermore, batch sizes and parallelism settings are adjusted dynamically based on task requirements and available resources.

Finally, the system leverages historical energy consumption data alongside real-time energy availability metrics to generate actionable recommendations for optimizing future task scheduling. By analyzing past energy usage patterns, including periods of high and low grid demand, the system identifies trends that can guide more energy-efficient task execution. For example, based on these insights, the system recommends scheduling large-scale training tasks during weekends when renewable energy generation, particularly solar and wind power, is at its peak, and grid demand is generally lower. The recommendation ensures that energy-intensive tasks, which require substantial computational power, are run during times when the electrical grid can accommodate the increased demand without straining resources. Additionally, by utilizing renewable energy at optimal times, the system helps reduce the carbon footprint of the AI data center, aligning with sustainability goals while maintaining high performance. The system continuously adjusts its recommendations based on evolving grid conditions and energy consumption trends, ensuring dynamic, real-time optimization of task execution for both energy efficiency and performance.

As illustrated above, the present disclosure provides technical advancements such as seamless profiling and categorization of the one or more AI workloads based on computational and energy requirements, optimized use of resources through dynamic scheduling aligned with energy availability, high resilience with transitional checkpoint method to ensure uninterrupted AI workload execution, and scalable parallel processing with adaptive configurations. The system's ability to handle large-scale, multi-domain tasks efficiently ensures cost-effective performance, robust fault tolerance through real-time hardware monitoring and fault management, and enhanced energy utilization. Additionally, detailed insights and actionable recommendations improve system management, future task scheduling, and issue resolution, further driving operational efficiency and sustainability.

A person skilled in the art will understand that the scope of the disclosure is not limited to scenarios based on the aforementioned factors and using the aforementioned techniques and that the examples provided do not limit the scope of the disclosure.

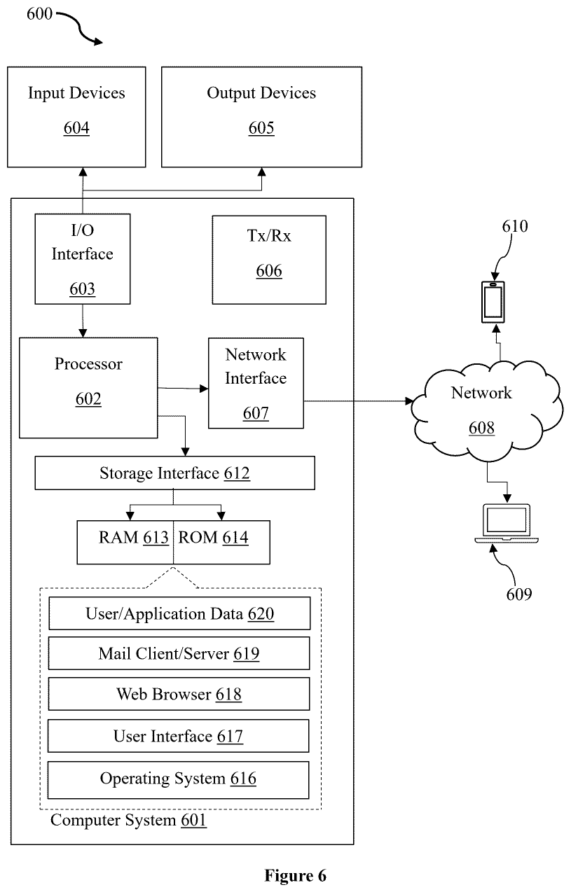

FIG. 6 illustrates a block diagram 600 of an exemplary computer system 601 for implementing embodiments consistent with the present disclosure. Variations of computer system 601 may be used for assistive cooking. The computer system 601 may include a central processing unit (“CPU” or “processor”) 602. The processor 602 may include at least one data processor for executing program components for executing user- or system-generated requests. A user may include a person, a person using a device such as those included in this disclosure, or such a device itself. Additionally, the processor 602 may include specialized processing units such as integrated system (bus) controllers, memory management control units, floating point units, graphics processing units, digital signal processing units, or the like. In various implementations the processor 602 may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor 602 may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor 602 may be disposed of in communication with one or more input/output (I/O) devices via I/O interface 603. Accordingly, the I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device 605 may be a user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver 606 may be disposed in connection with the processor 602. The transceiver 606 may facilitate various types of wireless transmission or reception. For example, the transceiver 606 may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor 602 may be disposed in communication with a communication network 608 via a network interface 607. The network interface 607 is adapted to communicate with the communication network 608. The network interface 607, coupled to the processor 602 may be configured to facilitate communication between the system and one or more external devices or networks. The network interface 607 may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (608) may include, without limitation, a direct interconnection, local area network (LAN), wide area network (WAN), wireless network (e.g., using Wireless Application Protocol), or the Internet, for example. Using the network interface 607 and the communication network 608, the computer system 601 may communicate with devices such as shown as a laptop 609 or a mobile/cellular phone 610. Other exemplary devices may include, without limitation, personal computer(s), server(s), fax machines, printers, scanners, various mobile devices such as cellular telephones, smartphones (e.g., Apple iphone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (601) may itself embody one or more of these devices.

In some embodiments, the processor 602 may be disposed of in communication with one or more memory devices (e.g., RAM 613, ROM 614, etc.) via a storage interface 612. The storage interface 612 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system 616, user interface application 617, web browser 618, mail client/server 619, user/application data 620 (e.g., any data variables or data records discussed in this disclosure) for example. The operating system 616 may facilitate resource management and operation of the computer system 601. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple IOS, Google Android, Blackberry OS, or the like.

The user interface 617 is for facilitating the display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, or widgets, for example. Graphical user interfaces (GUIs) may be employed, including, without limitation, Apple Macintosh operating systems' Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system 601 may implement a web browser 618 stored program component. The web browser 618 may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system 601 may implement a mail client/server 619 stored program component. The mail server 619 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, or WebObjects, for example. The mail server 619 may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client 620 may be a mail viewing application, such as Apple Mail, Microsoft Entourage, Microsoft Outlook, or Mozilla Thunderbird.

In some embodiments, the computer system 601 may store user/application data 621, such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Various embodiments of the disclosure provide a non-transitory computer readable medium and/or storage medium, and/or a non-transitory machine-readable medium and/or storage medium having stored thereon, a machine code and/or a computer program having at least one code section executable by a machine and/or a computer for assistive cooking. The at least one code section causes the machine and/or computer including one or more processors to perform the steps, which includes creating one or more energy profiles for execution of each of the one or more AI workloads based on one or more attributes associated with each of the one or more AI workloads. Further, each of the one or more energy profiles may be indicative of energy consumption characteristics of each of the one or more AI workloads. Further, the step may include categorizing each of the one or more AI workloads into one or more execution categories based on the created one or more energy profiles and a real-time energy availability of an electric grid. Further, the step may include creating a dynamic schedule for execution of each of the one or more AI workloads for a pre-defined time based on the categorization in the one or more execution categories. Further, the dynamic schedule may be based on the real-time energy availability of the electric grid and one or more user preferences for execution of the one or more AI workloads. Further, the step may include executing each of the one or more AI workloads for the pre-defined time in the AI data center based on the created dynamic schedule. Further, the execution of the one or more AI workloads may be optimized based on the real-time availability of the electrical grid.

Various embodiments of the disclosure encompass numerous advantages including methods and system for execution of one or more AI workloads in the AI data center. The disclosed system and method have several technical advantages, but not limited to the following:
1) Optimized Energy Efficiency: By profiling the one or more AI workloads based on energy requirements and scheduling them according to real-time energy availability, the system reduces overall energy consumption and maximizes resource efficiency, leading to cost savings and more sustainable operations.
2) Dynamic AI workload Management: The system creates energy profiles for each AI workload, allowing it to categorize and prioritize AI workloads based on their energy requirements. This ensures that high-priority AI workloads are executed when energy availability is optimal, improving overall system performance.
3) Real-Time Energy Monitoring: The system continuously tracks energy availability from the electrical grid, enabling proactive decision-making to avoid energy shortages or inefficiencies. This improves the overall performance of the AI data center by aligning AI workload execution with energy resources.
4) Improved Resource Utilization: By creating energy profiles and leveraging real-time data, the system ensures optimal usage of both computational and energy resources, minimizing idle times and enhancing throughput.
5) Proactive Energy Management: The system monitors energy inflow from the grid and detects fluctuations, automatically initiating corrective actions such as checkpointing or rescheduling to maintain AI workload efficiency, improving the overall resilience of the data center.
6) Energy Profile Creation: The present disclosure constructs detailed energy profiles for each AI workload based on multiple attributes like operational parameters and hardware resources, enabling precise energy consumption predictions. These profiles allow for smarter scheduling and resource allocation, improving both energy efficiency and AI workload execution times.
7) Dynamic AI workload Categorization: The system categorizes one or more AI workloads into three distinct execution profiles (low, moderate, and high energy) based on their energy needs and grid availability. The categorization provides flexibility in AI workload management, ensuring that energy-intensive AI workloads are executed when the electric grid can support them, while less demanding AI workloads are scheduled during periods of lower energy availability, optimizing overall system efficiency.
8) Adaptive Scheduling Strategy: The system adapts to real-time energy availability from the electrical grid, optimizing both energy costs and hardware utilization without compromising performance. This dynamic scheduling approach goes beyond traditional static scheduling methods, aligning AI workload execution with periods of high renewable energy availability and avoiding peak grid demand times to reduce costs and environmental impact.
9) Transitional Checkpoint Method: The checkpointing process saves the state of ongoing AI workloads, allowing the system to pause AI workloads and resume them later without data loss or disruption. The transitional checkpoint method facilitates smooth transitions between different energy consumption profiles, ensuring that AI workloads continue seamlessly despite fluctuations in energy availability.
10) Real-Time Energy Optimization: The system continuously adjusts AI workload execution based on real-time fluctuations in energy availability, promoting sustainable operations. By minimizing reliance on non-renewable energy sources during peak hours, the system reduces the carbon footprint associated with large-scale computations, contributing to a greener data center environment.
11) Cost-Effective Operations: Strategic scheduling and energy management significantly reduce operational costs by minimizing energy consumption during high-tariff periods and maximizing the use of off-peak, lower-cost energy. This approach, which is not commonly addressed in conventional systems, leads to long-term savings and more cost-effective operations.

In summary, these technical advantages address the challenges of traditional task scheduling and energy management methods, such as inefficiencies in power usage, suboptimal task allocation, lack of real-time energy monitoring, and the difficulty in adapting to fluctuating energy demands. The disclosed system solves these issues by providing automated energy-aware scheduling, dynamic resource allocation, and real-time energy profiling. These features enhance operational efficiency, ensuring that AI workloads are executed effectively while minimizing energy consumption. The system's ability to scale resources dynamically based on energy availability ensures that computational power aligns with AI workload requirements, improving both performance and sustainability. Additionally, the system's resilience to energy fluctuations and its fault tolerance further improve reliability, helping organizations maintain stability and efficiency even during peak energy demands.

The claimed invention of a system and a method for execution of AI workloads in an AI data center involves tangible components, processes, and functionalities that interact to achieve specific technical outcomes. The system integrates various elements such as processors, memory, databases, one or more AI workloads, one or more attributes associated with the one or more AI workloads, one or more energy profiles, one or more execution categories, real-time energy availability of the electric grid, for effective execution of the one or more AI workloads in AI data centers.

The present disclosure provides a concrete and practical technological solution to specific challenges in AI workload scheduling and energy management within AI data centers. It involves the tangible implementation of a resource-aware, energy-efficient AI workload scheduling system, which includes detailed mechanisms such as dynamic power allocation, intelligent AI workload distribution, real-time energy profiling, and automated energy consumption optimization. These elements are specified in a structured and practical manner to ensure efficient AI workload execution while minimizing energy load on the power grid. The system operates using specific technical features like AI workload energy profiling, workload migration based on energy availability, off-peak scheduling, and real-time energy demand monitoring, all designed to optimize energy consumption and performance in real-world scenarios.

The present disclosure introduces technical features related to AI workload scheduling and energy management in a non-trivial way. All of the components, along with their specific configuration and interaction, lead to significant improvements in the field of AI workload scheduling and execution. A person skilled in the art would not readily conceive of integrating features such as dynamic energy-aware AI workload prioritization, real-time energy consumption forecasting, and automated AI workload redistribution during power fluctuations, all synchronized to ensure optimal resource usage. The present disclosure requires a high level of technical insight and creative problem-solving, particularly in balancing computational efficiency, energy usage, and system stability, ensuring reliable AI workload execution while minimizing the impact on power grids and maintaining sustainability goals.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

What is claimed is:

1. A method for execution of Artificial Intelligence (AI) workloads in an AI data center, the method comprising:
creating, by an energy profiling unit of an application server, one or more energy profiles for execution of each of one or more AI workloads based on one or more attributes associated with each of the one or more AI workloads, wherein each of the one or more energy profiles is indicative of energy consumption characteristics of each of the one or more AI workloads;
categorizing, by a categorization unit of the application server, each of the one or more AI workloads into one or more execution categories based on the one or more energy profiles and a real-time energy availability of an electrical grid;
creating, by a scheduling unit of the application server, a dynamic schedule for execution of each of the one or more AI workloads for a pre-defined time based on the one or more execution categories, wherein the dynamic schedule is based on the real-time energy availability of the electrical grid and one or more user preferences for the execution of the one or more AI workloads; and
executing, by an execution unit of the application server, each of the one or more AI workloads for the pre-defined time in the AI data center based on the dynamic schedule, wherein the execution of the one or more AI workloads is optimized based on the real-time energy availability of the electrical grid.

2. The method as claimed in claim 1, wherein the execution of each of the one or more AI workloads comprises:
initiating execution of a first AI workload for the pre-defined time;
transitioning from the first AI workload to a second AI workload on the execution of the first AI workload for the pre-defined time;
creating a checkpoint associated with the first AI workload, wherein the checkpoint stores a state of ongoing execution of the first AI workload and data associated with the ongoing execution of the first AI workloads;
initiating execution of the second AI workload from the one or more AI workloads for the pre-defined time; and
resuming execution of the first AI workload for the pre-defined time based on the checkpoint on the execution of the second AI workload for the pre-defined time.

3. The method as claimed in claim 1, wherein the one or more AI workloads comprises at least one of Data Processing workloads, Machine Learning workloads, Deep Learning workloads, Natural Language Processing (NLP) workloads, Generative AI workloads, Computer Vision workloads, wherein the one or more AI workloads corresponds to either a training task or an inference task, and wherein the AI data center is a cloud-based data center configured for execution of the one or more AI workloads.

4. The method as claimed in claim 1, wherein the one or more attributes comprises operational parameters, data precision values, a page size, Graphics Processing Unit (GPU) hardware resources, input data format, type of languages, data size, data structure, preferred type of a pre-trained model, a pre-trained model framework and version, a checkpoint interval, a backup frequency, memory requirements, and parallelism settings, wherein the one or more attributes are indicative of an estimated energy consumption by each of the one or more AI workloads.

5. The method as claimed in claim 1, wherein the one or more execution categories comprises a low priority category, a medium priority category, and a high priority category, and wherein the pre-defined time is one of a first pre-defined time, a second pre-defined time, and a third pre-defined time.

6. The method as claimed in claim 5, wherein the low priority category comprises of a first set of AI workloads from the one or more AI workloads which are scheduled during the first pre-defined time, the energy availability of the electrical grid being below a first pre-defined threshold during the first pre-defined time,
wherein the medium priority category comprises of a second set of AI workloads from the one or more AI workloads which are scheduled during the second pre-defined time, the energy availability of the electrical grid being within a range of the first pre-defined threshold and a second pre-defined threshold during the second pre-defined time, and
wherein the high priority category comprises of a third set of AI workloads from the one or more AI workloads which are scheduled during the third pre-defined time window, the energy availability of the electrical grid being greater than the second pre-defined threshold during the third pre-defined time.

7. The method as claimed in claim 1, wherein creating the one or more energy profiles for each of the one or more AI workloads comprises:
receiving energy limitation information associated with the electrical grid, wherein the energy limitation information comprises at least one of day-of-use constraints and peak power limits;
receiving infrastructure information associated with the AI data center, wherein the infrastructure information comprises a hardware inventory and a software inventory, wherein the hardware inventory comprises at least one of Graphics Processing Unit (GPU), Central Processing Unit (CPU), memory, and network;
receiving the one or more user preferences for the execution of the one or more AI workloads, wherein the one or more user preferences comprises data precision, size, format, and framework; and
performing one or more preprocessing operations on the energy limitation information, the infrastructure information, and the one or more user preferences, wherein the one or more preprocessing operations corresponds to a normalizing operation and a validation operation.

8. The method as claimed in claim 7, wherein creating the one or more energy profiles for each of the one or more AI workloads comprises:
creating a baseline energy profile for each of the hardware inventory by assessing a performance and the energy consumption characteristics of each of the hardware inventory and the software inventory;
estimating one or more computational requirements for execution of the one or more AI workloads based on the one or more user preferences and data associated with the one or more AI workloads;
estimating an energy consumption requirement for execution of the one or more AI workloads based on the one or more computational requirements;
optimizing the energy consumption characteristics by adjusting a computational load distribution across the hardware inventory, wherein the adjusting is based on a trade-off between performance and energy efficiency in light of the one or more user preferences; and
creating the one or more energy profiles comprising the energy consumption requirement for the hardware inventory and the software inventory based on the adjusting and the energy limitation information.

9. The method as claimed in claim 1, further comprising:
generating one or more recommendations for updating the one or more energy profiles based on the real-time energy availability of the electrical grid.

10. The method as claimed in claim 7, further comprising:
continuously monitoring for energy fluctuations within the hardware inventory and the real-time energy availability of the electrical grid;
identifying a faulty hardware inventory based on the monitoring; and
initiating creation of a checkpoint based on the energy fluctuations and the faulty hardware inventory.

11. A system to execute Artificial Intelligence (AI) workloads in an AI data center, the system comprising:
an application server, wherein the application server comprises:
a processor, and
a memory communicatively coupled with the processor, wherein the memory is configured to store one or more executable instructions, which cause the processor to:
create one or more energy profiles for execution of each of one or more AI workloads based on one or more attributes associated with each of the one or more AI workloads, wherein each of the one or more energy profiles is indicative of energy consumption characteristics of each of the one or more AI workloads;
categorize each of the one or more AI workloads into one or more execution categories based on the one or more energy profiles and a real-time energy availability of an electrical grid;
create a dynamic schedule for execution of each of the one or more AI workloads for a pre-defined time based on the one or more execution categories, wherein the dynamic schedule is based on the real-time energy availability of the electrical grid and one or more user preferences for the execution of the one or more AI workloads; and
execute each of the one or more AI workloads for the pre-defined time in the AI data center based on the dynamic schedule, wherein the execution of the one or more AI workloads is optimized based on the real-time energy availability of the electrical grid.

12. The system as claimed in claim 11, wherein the processor is configured to execute each of the one or more AI workloads by:
initiating execution of a first AI workload for the pre-defined time;
transitioning from the first AI workload to a second AI workload on the execution of the first AI workload for the pre-defined time;
creating a checkpoint associated with the first AI workload, wherein the checkpoint stores a state of ongoing execution of the first AI workload and data associated with the ongoing execution of the first AI workloads;
initiating execution of the second AI workload from the one or more AI workloads for the pre-defined time; and
resuming execution of the first AI workload for the pre-defined time based on the checkpoint on the execution of the second AI workload for the pre-defined time.

13. The system as claimed in claim 11, wherein the one or more AI workloads comprises at least one of Data Processing workloads, Machine Learning workloads, Deep Learning workloads, Natural Language Processing (NLP) workloads, Generative AI workloads, Computer Vision workloads, wherein the one or more AI workloads corresponds to either a training task or an inference task, and wherein the AI data center is a cloud-based data center configured for execution of the one or more AI workloads.

14. The system as claimed in claim 11, wherein the one or more attributes comprises operational parameters, data precision values, a page size, Graphics Processing Unit (GPU) hardware resources, input data format, type of languages, data size, data structure, preferred type of a pre-trained model, a pre-trained model framework and version, a checkpoint interval, a backup frequency, memory requirements, and parallelism settings, wherein the one or more attributes are indicative of an estimated energy consumption by each of the one or more AI workloads.

15. The system as claimed in claim 11, wherein the one or more execution categories comprises a low priority category, a medium priority category, and a high priority category, and wherein the pre-defined time is one of a first pre-defined time, a second pre-defined time, and a third pre-defined time.

16. The system as claimed in claim 15, wherein the low priority category comprises of a first set of AI workloads from the one or more AI workloads which are scheduled during the first pre-defined time, the energy availability of the electrical grid being below a first pre-defined threshold during the first pre-defined time,
wherein the medium priority category comprises of a second set of AI workloads from the one or more AI workloads which are scheduled during the second pre-defined time, the energy availability of the electrical grid being within a range of the first pre-defined threshold and a second pre-defined threshold during the second pre-defined time, and
wherein the high priority category comprises of a third set of AI workloads from the one or more AI workloads which are scheduled during the third pre-defined time window, the energy availability of the electrical grid being greater than the second pre-defined threshold during the third pre-defined time.

17. The system as claimed in claim 11, wherein the processor is configured to create the one or more energy profiles for each of the one or more AI workloads by:
receiving energy limitation information associated with the electrical grid, wherein the energy limitation information comprises at least one of day-of-use constraints and peak power limits;
receiving infrastructure information associated with the AI data center, wherein the infrastructure information comprises a hardware inventory and a software inventory, wherein the hardware inventory comprises at least one of Graphics Processing Unit (GPU), Central Processing Unit (CPU), memory, and network;
receiving the one or more user preferences for the execution of the one or more AI workloads, wherein the one or more user preferences comprises data precision, size, format, and framework; and
performing one or more preprocessing operations on the energy limitation information, the infrastructure information, and the one or more user preferences, wherein the one or more preprocessing operations corresponds to a normalizing operation and a validation operation.

18. The system as claimed in claim 17, wherein the processor is configured to create the one or more energy profiles for each of the one or more AI workloads by:
creating a baseline energy profile for each of the hardware inventory by assessing a performance and the energy consumption characteristics of each of the hardware inventory and the software inventory;
estimating one or more computational requirements for execution of the one or more AI workloads based on the one or more user preferences and data associated with the one or more AI workloads;
estimating an energy consumption requirement for execution of the one or more AI workloads based on the one or more computational requirements;
optimizing the energy consumption characteristics by adjusting a computational load distribution across the hardware inventory, wherein the adjusting is based on a trade-off between performance and energy efficiency in light of the one or more user preferences; and
creating the one or more energy profiles comprising the energy consumption requirement for the hardware inventory and the software inventory based on the adjusting and the energy limitation information.

19. The system as claimed in claim 11, wherein the processor is configured to generate one or more recommendations for updating the one or more energy profiles based on the real-time energy availability of the electrical grid.

20. The system as claimed in claim 17, wherein the processor is configured to:
continuously monitor for energy fluctuations within the hardware inventory and the real-time energy availability of the electrical grid;
identify a faulty hardware inventory based on the monitoring; and
initiate creation of a checkpoint based on the energy fluctuations and the faulty hardware inventory.

21. A non-transitory computer-readable storage medium having stored thereon, a set of computer-executable instructions causing a computer comprising one or more processors to perform steps comprising:
creating one or more energy profiles for execution of each of one or more Artificial Intelligence (AI) workloads based on one or more attributes associated with each of the one or more AI workloads, wherein each of the one or more energy profiles is indicative of energy consumption characteristics of each of the one or more AI workloads;
categorizing each of the one or more AI workloads into one or more execution categories based on the one or more energy profiles and a real-time energy availability of an electrical grid;
creating a dynamic schedule for execution of each of the one or more AI workloads for a pre-defined time based on the one or more execution categories, wherein the dynamic schedule is based on the real-time energy availability of the electrical grid and one or more user preferences for the execution of the one or more AI workloads; and
executing each of the one or more AI workloads for the pre-defined time in an AI data center based on the dynamic schedule, wherein the execution of the one or more AI workloads is optimized based on the real-time energy availability of the electrical grid.
